(19) United States
(12) Patent Application Publication
(10) Pub. No.: US 2011/0246673 A1
(43) Pub. Date: Oct. 6, 2011

(54) Method and System for Optimizing the Content and Transfer of Media Files

(76) Inventors: Kelly Y. Kishore, San Jose, CA (US); Gerard M. X. Fernando, Mountain View, CA (US)

(21) Appl. No.: 12/858,404

(22) Filed: Aug. 17, 2010

Related U.S. Application Data
(60) Provisional application No. 61/341,490, filed on Apr. 1, 2010.

(51) Int. Cl. G06F 15/16

(52) U.S. Cl. 709/247

(57) ABSTRACT

Media files, including video, are compressed using information about subsequent processing, or transcoding, that will later be applied to the files. The compression allows the files to be uploaded over a limited-bandwidth device more quickly or less expensively than would otherwise be required. The files are decompressed prior to the transcoding process.

### RELATED APPLICATION

This applications claims priority of U.S. application Ser. No. 61/341,490 of the present inventors filed Apr. 1, 2010, entitled Method and apparatus of optimizing content uploads, incorporated herein by reference.

### BACKGROUND

The present invention relates to the compression of files containing media data, such as video.

In particular, the invention relates to the compression of a media file preparatory to uploading of the file to another computer.

Files containing media, including video, audio, or photographs, are often relatively large. Such files may contain uncompressed data, or the data may be compressed. Files containing media data are often put into a structured format. A few common formats for such video files are AVI (Audio Video Interleaved), MPEG-2 and MPEG-4 (standards developed by the Moving Pictures Expert Group). For example, a video camera may generate files in AVI or MPEG-2 format, and these files may be directly transferred to a local computer. Such files may include some compression, but limited time or processing capabilities may limit the efficiency of the compression.

It is sometimes desirable to transfer the media data to another computer, such as uploading the data to a server. In some cases, it is known that the server will then apply significant computational resources to efficiently compress the media data using a different codec, such as, for video, the H.264 format. Also, multiple compression algorithms or compression parameters may be applied to generate multiple instances of the file that may be intended for different purposes, such as generating one instance of the media data that would be appropriate to download to a high definition display using a high bandwidth connection, and another instance of the media data that would be appropriate to download to a portable handheld device using a low bandwidth connection.

Most broadband data services exhibit data rate asymmetry with the uplink speed being much lower than the downlink speed. In addition, bandwidth utilization may be charged based on consumption or even limited to a quota for a given period. Furthermore, a large number of simultaneous uploads of high quality content will congest the network, even if the client and the transcoding servers reside on the same local network. As a result, uploading video or other media content can be time-consuming, costly, limited, and inconvenient.

### BRIEF SUMMARY

The present invention is defined by the following claims, and nothing in this section should be taken as a limitation on those claims. Methods and systems are described for compressing a file containing media data which incorporate knowledge of subsequent processing that will later be applied to those files. The file is then to be transferred, or uploaded, to another computer, such as a server, where the file is decompressed or returned to a standard format for the applicable media. The file then undergoes a transcoding process, where significant additional processing is applied to greatly compress the file with minimal loss of information.

In one scenario of application of the invention, a media file, such as an MPEG-2 video file, is generated by a digital video camera. The file is transferred to a local computer. The file is to be uploaded to a server, such as a server that hosts and distributes video over the internet. The server has significant computational power, and is able to exert significant amounts of computational power to efficiently compress the video, such as to, for example, the H.264 format. This compression will reduce the bandwidth requirements when the video is later consumed by other computers.

One embodiment of the present invention is the application of compression to the media file on the local computer so that the file can be uploaded to the server more quickly. The compression that is applied incorporates information about the processing, or transcoding, that will later be applied to the file on the server. For example, when it is known that the transcoding will apply a certain amount of quantization to discrete cosine transform (DCT) components within the image, then that information can be used to apply lossy compression to the MPEG-2 data, but the information that is lost in this compression would have been lost in the subsequent transcoding processing, so there is no or minimal additional loss when the file is subsequently processed by the transcoder. The parameters used by the transcoder on the server may be specified by the local, or client, computer and communicated to the transcoder, or those parameters may be communicated from the server, where the transcoder resides, to the local computer.

### BRIEF DESCRIPTION OF THE DRAWINGS

The present invention may be further understood from the following description in conjunction with the appended drawings. In the drawings:

FIG. 1 is a block diagram of an environment of the invention.

FIG. 2 is a flowchart of a global lossless compression algorithm.

FIG. 3 is a flowchart of a segmented lossless compression algorithm.

FIG. 4 is a flowchart of a lossy baseband compression algorithm.

FIG. 5 is a flowchart of a lossy intelligent compression algorithm.

FIG. 6A is a flowchart for the processing on a client, FIG. 6B is a flowchart for the processing on a server, and FIG. 6C is a flowchart for the processing of the transcoder. FIG. 6A, FIG. 6B, and FIG. 6C will be referred to as FIG. 6 below, when reference is to the composite.

### DETAILED DESCRIPTION

Described herein are methods and apparatuses that can be used to compress computer files that contain media files, so that the files can be transferred, or uploaded, to another computer, such as a server, more quickly. After uploading, the files are decompressed (fully or partially) then transcoded into a new format or structure that incorporates improved file compression.

The methods and techniques described herein may be applied to computer files that contain video data, audio data, photographic data, or any combination of these. They may be applied to document files that include text or other data in addition to video, audio, or photographic data.

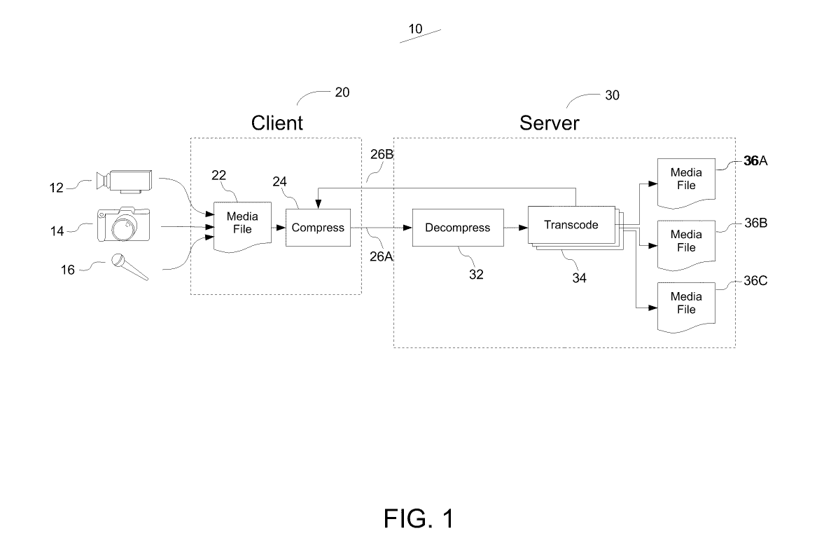

FIG. 1 shows an environment 10 of the invention. The environment includes a media data source, such as a video camera 12, a camera 14, or a microphone 16, a client computer 20 that contains a media file 22 and a means for compression 24 of that file, a server computer 30 that contains a means for decompression 32 of the file, a means for transcoding 34 to generate one or more instances of the media file 36 with different compression properties. A means of communication 26 between the computers is also present, represented conceptually in FIG. 1 by an upload path 26A for passing information to the decompression block 32 and an optional download path 26B. In practice, the same physical path may be used for both.

In one embodiment, a media file 22 is generated on the client computer 20. The media file 22 contains data acquired from a video recorder 12, a camera 14, a microphone 16, or other media source. The file may contain a single media data from a single source, or may include data acquired from multiple sources at a same or different times. The file may be a text document that also contains pictures, photographs, videos, or combinations thereof. The media file may come directly from a source, or it may have been edited or modified since it was acquired by the source, or may be a streamed rendering of edited video. The file may reside on a computer data storage medium, or may reside in computer-readable memory. Media files are of particular interest because they can be very large, they store data in a structured format, and because they can undergo significant amounts of compression using a variety of techniques. Some of these techniques can be computationally intensive.

The media file 22 is compressed by block 24 using any of a variety of techniques described herein, although other techniques may also be used. The compression is useful because it allows the file to be transferred to a server computer 30 over a limited bandwidth connection in less amount of time than would otherwise be required. The compression that is applied on the client may be, in part, a function of the transcoding that will be applied by the server, although in other embodiments this may not be the case.

The client 20 may be a first computer, and the server 30 may be a second computer, although alternatives are possible. For example, both may be servers.

The communication path 26 may be an internet connection utilizing the hypertext transfer protocol (HTTP) or the file transport protocol (FTP). Other communication techniques may also be used, as is known in the art. The data communication rates between the two computers may be different in different directions. For example, it is common that the data rate from a client to a server is significantly slower than the data rate from a server to a client. Slow data rates from the first computer to the second computer are a strong motivating factor to compress the media files prior to transfer of those files, as smaller files will require less time to transfer. Costs associated with data transfer and memory constraints are other motivating factors for compressing the media files prior to transfer.

On the server 30, the media file is decompressed 32 to return it to a data structure format that can be read by the transcoder 34. A transcoder performs the direct digital-to-digital conversion of the media data from one encoding to another. In one embodiment, the transcoder 34 leverages the compression 24 that was applied in the course of its processing. In another embodiment, the transcoder 34 does not leverage the compression 24. The original media file 22 may be in, for example, AVI format containing MPEG-2 video, and the output of the transcoder may be in an MPEG-4 file format, containing H.264 video. Other formats and combinations of formats are also possible. The transcoder 34 on the server 30 may convert the media to a single media file 36, or it may generate two or more media files 36A, 36B, etc., each with different compression properties. For example, the various files may have different video aspect ratios, pixel resolutions, video rates, audio sampling rates, number of audio channels, or different amounts of quantization to the underlying video our audio, or any combination these or other parameters. After transcoding, the file or files 36 may be returned to the client 20 or another system. They may also remain on the server 30 for later distribution to other computers or clients.

Some information passed from the client computer 20 to the server computer 30 via the communication path 26A may not be compressed 24 and decompressed 32. For example, metadata relating to the details of the compression 24 may be passed, either with compressed media data or in a separate delivery path other than the media data, to the server computer 30.

To achieve very high video compression rates with minimal degradation in quality, sophisticated compression algorithms may be applied to the data. As is known in the art, one technique for compressing blocks of pixel data is by searching for similar blocks of data within the same or in other frames, and then storing a pointer to this other location and also storing residual difference data. Combinations of frames and fractional pixel data may be used, as is known in the art. Such compression techniques can be extremely computationally extensive, making them impractical for real-time implementation on a single processor on the client 20 prior to uploading the file to the server 30. However, information about the output of the transcoded data, such as the pixel resolution, quantization, and video rate may enable some amount of compression to be applied to the data prior to uploading, such that after the data is transcoded, there will be no or minimal additional losses.

By way of non-limiting example, consider the situation where a user has some high-resolution MPEG-2 videos and would like to transcode them into the H.264 video format for distribution to an iPod (manufactured by Apple Incorporated, Cupertino, Calif.). Transcoding is the process of converting the files from one digital format into another digital format. The user has access to a server on the internet where the files can be uploaded and transcoded to the desired format. To leverage the transcoding service, the user will upload the media file. The server will then perform the transcoding and return the file in a specified format, in this case an iPod-compatible format. Assume, continuing the example, that the original content file is 300 MB (megabytes) in size, with the content having a resolution of 1920 by 1080 pixels with a frame rate of 50 frames per second. Also assume that the upstream cable modem bandwidth from the client to the server is 2 Mbps (megabits per second), so it would take about 20 minutes (300 MB*8 bits/byte/2 Mbps/60 seconds per minute) to perform just the uploading task. The transcoding engine, using multiple high-speed processors, completes the task in less than one minute and the result is a H.264 file with a resolution of 640 by 480 pixels with a frame rate of 25 frames per second. The download bandwidth from the server to the client is 16 Mbps, so the download process only takes a few seconds. In this example, the entire cycle time from where the user began the upload process to receipt of the transcoded file was roughly 21 minutes. One way to improve the user experience and bring additional value to such a service is by significantly reducing the time it takes for this entire cycle to complete. By compressing the content to be uploaded, the limited upload bandwidth can be better utilized.

In order for compression before uploading to be worthwhile, the following inequality must hold true:

A/C+A′/D<(A−A′)/N (equation 1)

where A is the original file size, A′ is the client-compressed files size, C is the compression execution rate, D is the decompression execution rate, and N is the network transfer rate.

Equation 1 is a simplified equation, as it may be desirable to include other factors such as video quality and power consumption. The client can easily determine the value of A. A′ can be determined from a threshold value, as is described below. C is dependent on the client's resources, but can still be estimated using information from the client's browser application. D is dependent on the server's resources, but for most instances, it can be assumed that the decompression execution rate is significantly higher than the client due to the amount of resources that would probably be available on the server. N can either be determined before transmission occurs, fluctuated as the content is being transmitted, predefined by the client application, or it can even be user defined. A simple approach would be to set N=128 kbps, or another value or estimated value of the network transfer rate from the client to the server. A more complex approach would be to dynamically change the value of N as the transfer rate fluctuates.

The compression execution rate, C, may be predefined for each of various compression algorithms, or it can be stored in and later looked up in a table, or it can be provided by the server. For example, entries such as zip compression of a 100 MB file on a desktop system, or replacing VLC (variable length coding) with CAVLC (context-adaptive variable length coding) of a 100 MB file would take 30 seconds.

Additionally or separately, a target threshold describing how much the original file should be compressed can be used to determine which of several compression approaches should be applied. If, as before, A is the original file size, and A″ is the target, or estimated, size of the transcoded file, then a threshold, T, can be defined as the target compression ratio and be made for an initial compression on the client by defining a threshold factor X.

T=X*(1−A″/A) (equation 2).

One approach is to select a threshold that reflects a file size half way between the original and the final, transcoded sizes, by defining X=0.5 as in equation 2. Multipliers greater than 0.5 or less than 0.5 may be used. The target size of the client-compressed file, A′, is given by:

A′=A*(1−T) (equation 3).

The original file size may also be less than the target transcoded file size. For example, H.264 content captured by a camcorder is targeted for transcoding to MPEG-2 format for the distribution by DVD or digital broadcast systems.

Another approach is to follow a basic threshold model, T, where X is a function of the format type of A.

T=X*A (equation 4)

For example, if the input format is detected to be a relatively older format such as MPEG-1 then X can be expected to be some factor such as 0.75.

A separate approach is where the threshold can be defined as the quality ratio based on the quality (subjective and objective) difference, either between the original and the client-compressed files, the original and the target transcoded files, or the client-compressed and target transcoded files. This is a different dimension to the threshold in that it is quality-based threshold versus the earlier filesize-based threshold.

For the condition where the original file is lesser than the target transcoded file, the condition itself doesn't necessarily exclude any opportunity for further compression. For example, an original content in H.264 format can be further compressed before the uploading process even if the target transcoded format such as MPEG-2 will result in a larger output. Another example, the quality of original video is noisy with blocking artifacts and the targeted transcoded video is smoothed and deblocked.

These are some examples of many approaches in using a threshold. Any of these approaches may be applied in conjunction or separately to effectively determine the threshold for selecting the appropriate compression algorithms.

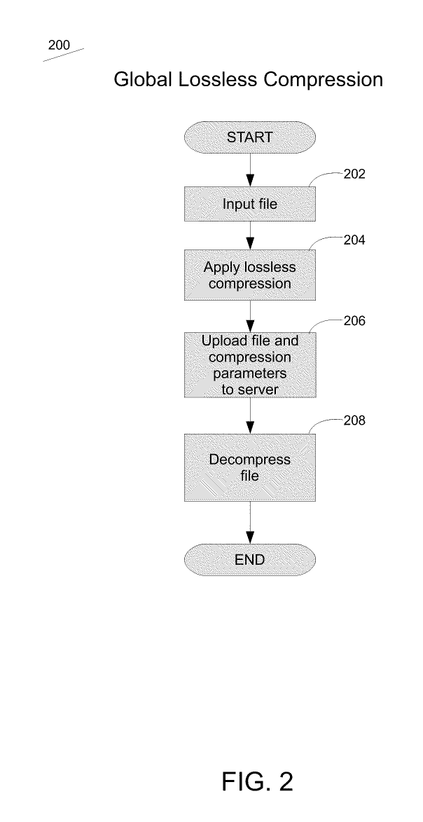

Four approaches are described by which the media file can be compressed. They are described in conjunction with FIGS. 2 through 5, described below. Although the techniques are described individually, one skilled in the art will recognize that various components of the algorithms can be combined to achieve higher compression rates or faster compression processing. Other techniques for compression may also be used.

FIG. 2 shows a flowchart for performing lossless compression (200) on an entire media file. In a first step the file is input, or loaded (202). Lossless compression, such as ZIP, is then applied to the file (204). The file is uploaded to the server, along with any parameters, if any are needed, that are required to decompress the file (206). The compression parameters may be incorporated into the file, the name of the file, or may be conveyed in a separate file or within the header of the file transfer protocol, such as the HTTP header. The file is decompressed (208) on the server before the transcoding process.

An advantage of the compression algorithm of FIG. 2 is simplicity, because format parsing is not necessary. However, it provides a minimal level of compression as it does not take advantage of context. Depending upon the applied compression algorithm, this process may require that the compressed file be sequentially decompressed, so that an Nth section cannot be decompressed until the 0^{th} through N−1th sections have also been decompressed.

In general commonly used lossless compression cannot compress most video and audio portions of content files very well since video and audio codecs already have applied some form of lossless compression by specification. However, at a higher level, such as at the file format level, there may be some opportunity to achieve increased compression. In order to determine if such basic compression approach may be effective without performing the actual compression, the file format characteristics can be inspected. For example, the content file may use a file format such as MPEG2 TS, which is known to have packet stuffing, a repeated pattern to fill up a portion of the structure. Approaches such as this can provide significant reduction in determining if an compression algorithm will be effective without performing the compression itself.

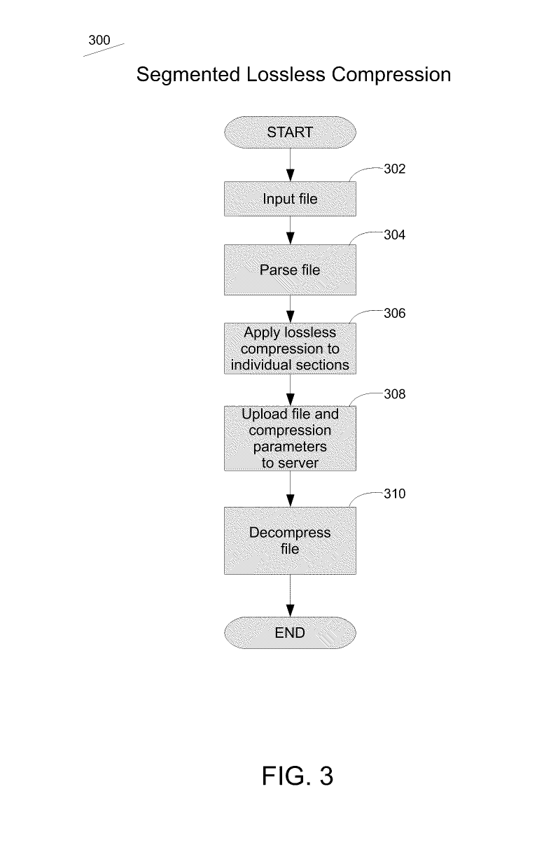

FIG. 3 shows a flowchart for performing lossless compression on portions, or segments, of a media file (300). In a first step the file is input, or loaded (302). The file is then parsed (304). Lossless compression can then be applied (306) to portions of the entire file using methods like CAVLC, where the underlying compression mechanism is either interchanged or supplemented. Portions of MPEG-2 video are already compressed by VLC; however, applying CAVLC instead of VLC will provide better compression on those portions as well as other portions. The client uploads (308) the content to the server, along with any necessary compression parameters or other information for decompressing or interpreting the file. For example, CAVLC is not specified in the MPEG-2 video standard, so either the client and server must already know that this method is being used, or the method is signaled either through metadata which may be part of the MPEG-2 file or stream, or through another channel such as HTTP post and get. If it is signaled, then other forms of compression can be interchanged as well. With the required information, the file is decompressed (310) prior to transcoding.

Unlike the global lossless compression (200) approach, the segmented lossless compression (300) technique requires an ability to parse the content of the file, thus resulting in more complexity. However, interchanging or supplementing the compression algorithm with minimal structural changes provides at least several benefits over the global approach. First, significantly better compression can be achieved because context adaptive lossless compression can be effectively applied due to maintaining most if not all of the structure of the format. Second, it maintains features such as random access since the format is kept intact. Thus, it is not required that the 0^{th} through (N−1)th portions be decompressed before accessing the Nth portion. Third, minimal coding changes to existing software may be used, as this technique is mostly similar to the standardized format. Finally, the latter technique uses minimal usage of additional license encumbered technologies, where converting to a fully standardized compression may result in higher license fees. The tradeoff for these benefits is that more complexity is required on the client to perform the parsing and compression.

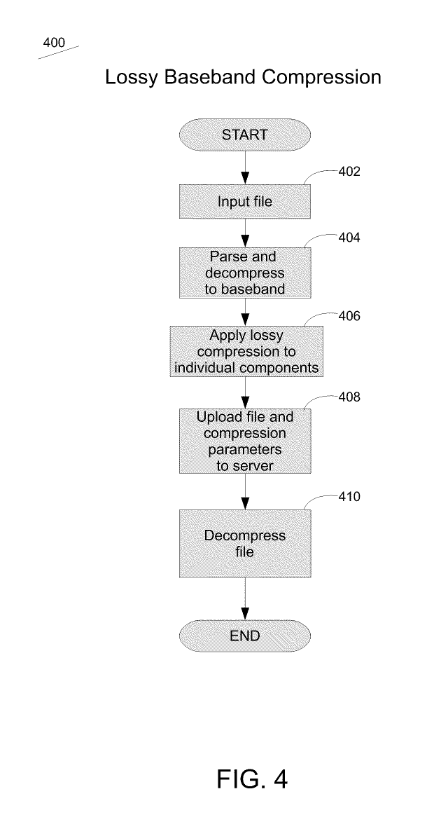

FIG. 4 shows a flowchart for performing lossy baseband compression (400) on a media file. In first step, the file is input, or loaded (402). The file is then parsed and decompressed to baseband (404). This means that, for example, pixel values are generated associated with each pixel location, where they may have previously been encoded across multiple pixels using a discrete cosine transform (DCT). Lossy compression algorithms or techniques are then applied to portions of the data (406), such as subsampling, resizing, applying certain transformations, quantizing, or restructuring of the format. While lossy compression is applied to, for example, pixel brightness values, no compression or lossless compression may be applied to the metadata or the file control data. The file, along with any requisite compression information, is uploaded to the server (408), where the file is then decompressed (410).

The lossy baseband compression (400) technique may result in an intermediate compressed content file with the file size between the original and the target. In one example, the file resolution of 1920×1080 may be reduced to 640×480, every other frame may be dropped, the interval of keys frames increased, and the file may then be re-encoded using MPEG-2 or H.264 prior to uploading. Another approach is to not reduce the resolution nor reduce the frame rate, but just decode the content and transcode into another format which uses more advanced coding techniques than what was used for the encoding of the original content.

One advantage to the lossy baseband compression (400) technique is that the intermediate form may follow a compression standard, so other entities that support the compression standard may properly consume the content. Another advantage is that existing encoders which implement the standard may be used, thus reducing time to market development time. A disadvantage is that this is the most computationally intensive option because the client will need to perform estimation, compensation, transformation, quantization, entropy coding, and so forth. This approach may also introduce further errors because it will be different in format compared to the original and the transcoding formats. Additionally, this approach may not take into consideration the format characteristics of the source codec and the target codec which will be used on the server for the purpose of transcoding. However, a strategy to establish a selection of an effective intermediate format can be established to alleviate the disadvantages.

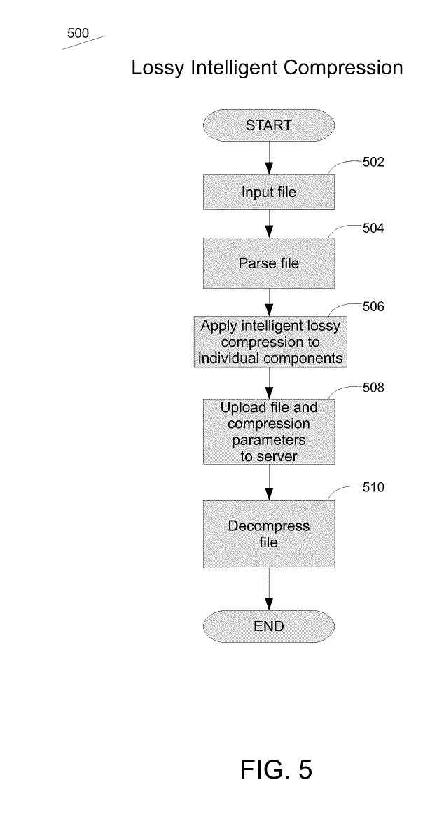

FIG. 5 shows a flowchart for performing lossy intelligent compression (500) on a media file. In a first step the file is input, or loaded (502) and then parsed (504). Lossy compression can then be applied (506) intelligently where a portion of the content is modified to better improve the compression ratio. For example, MPEG-2 intra-frame prediction has a predictor for the DC coefficient but not for the AC coefficients. One improvement in compression can result from the replacement of the algorithm for the prediction of the DC coefficient. Another source of improvement can result from using an AC coefficient predictor algorithm. The DCT coefficients are already VLC compressed, so first they will need to be VLC decompressed; however, the inverse DCT transform operation does not need to be performed. The quantization of the DCT coefficients can be increased, which decreases the size of the DCT coefficients and also results in some loss of information. One simple method is to increase the quantization value uniformly or selectively in the entire picture by one or two, which will reduce the file size significantly. This simple operation is not compute intensive so it can be executed on the client very easily. In addition, the quantization matrix in the MPEG-2 can be replaced with another one that would be suited for transcoding to H.264, and then applying it after dequantizing. Additionally or alternatively, a portion of the data stream may be modified without modifying other portions.

There are other additional algorithms such as using a different spatial prediction algorithm similar to H.264 that can be applied to each of the intra coded (I) frames. These are more compute intensive than the methods of the previous paragraph, so the gain versus time tradeoff must be taken into consideration accordingly.

Because I-frames are self contained, they can be manipulated with less operations than predictive (P) or bi-directionally predictive (B) frames; however, it is important to note that the following and previous frames may be dependent on them, so propagation errors may occur. If the final content from the transcoding server is to be of high quality, then it is critical to minimize this loss.

After intelligent lossy compression is applied (506), the file and any required associated compression parameters are uploaded to the server (508), where the file is then decompressed (510) preparatory to being transcoded.

In addition to the preceding compression techniques, other or new compression algorithms may become available over time, and they may be applied to the above scenarios.

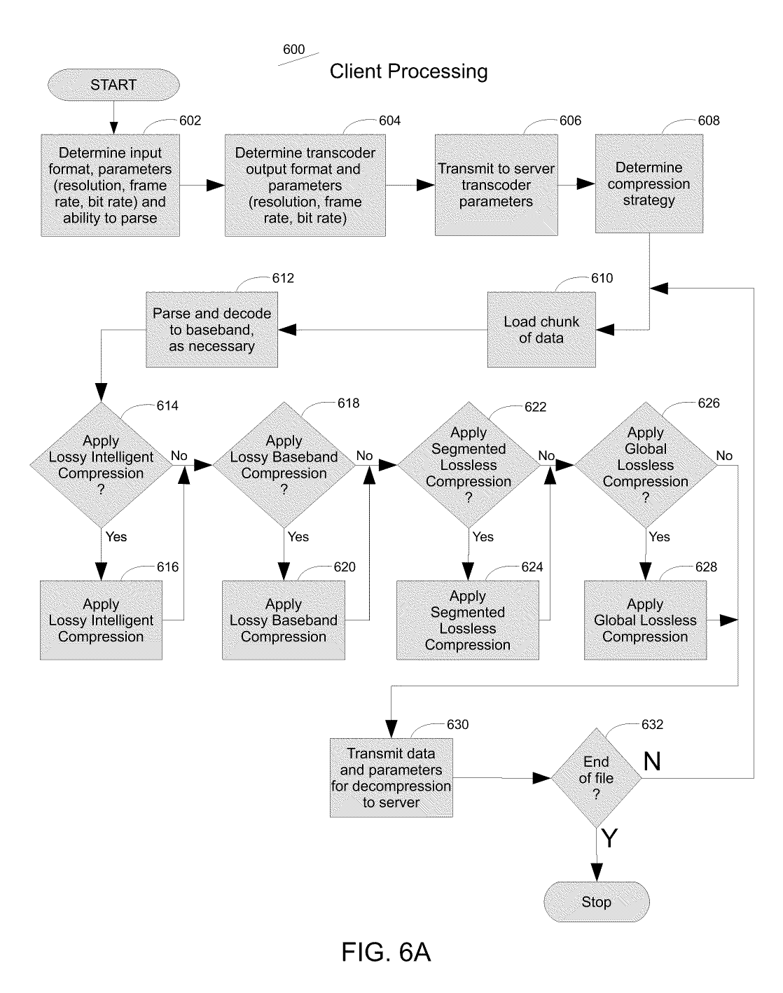

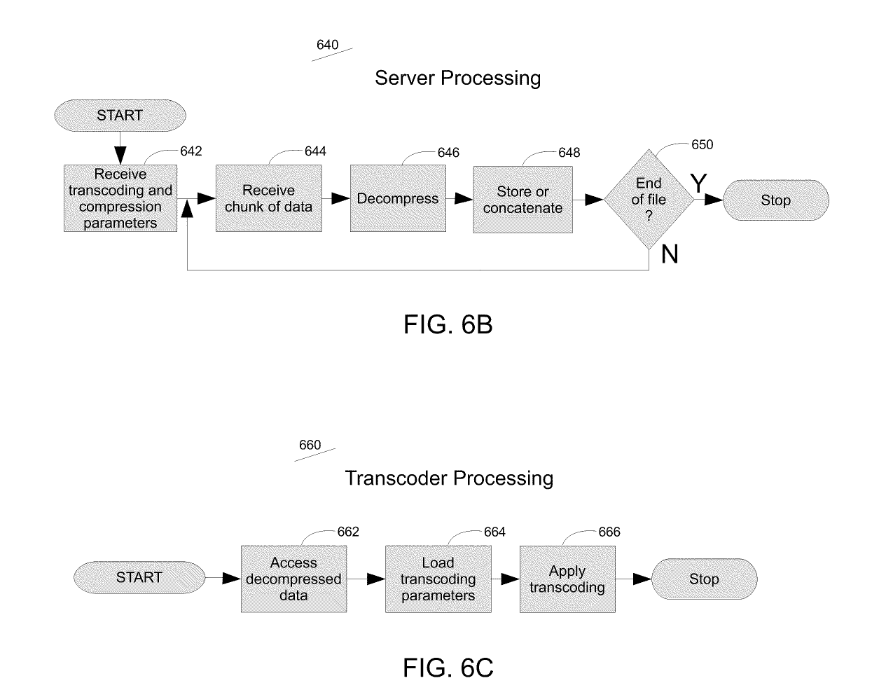

FIG. 6A is an example of a flowchart of the processing that may be applied on a client (600). In an initial step, the client determines (602) parameters associated with the media file, such as the format, pixel resolution, frame rate, and the bit rate, or the number of bits of data per second of media. For example, the media may be stored in an MPEG-2 structure, with a resolution of 1920 pixels wide by 1080 pixels high, 24 frames per second (fps), and 22 megabits per second (Mbps). The server also assesses its ability to parse the structure of the input media file, and to parse substructures within that media file. Further, the client determines (604) the desired output format of the transcoder and the associated parameters, such as the pixel resolution, frame rate, and bit rate. These parameters may be specified by a user via a user interface, or determined in some other way. They may, for example, be a format and parameters that are supported by a particular media device, such as a cell phone or iPod, along with an expected minimum bandwidth for communicating with that device. When multiple output formats are desired, the parameters associated with the highest value may used. For example, when the outputs of H.264 (640×480, 24 fps), H.264 (960×640, 12 fps), and MPEG-2 (720×480, 24 fps) are desired then the parameters may be 960×480 and 24 fps. The transcoder parameters are sent (606) to the server for use by the transcoder.

Based on the input, or source, parameters and the desired target parameters, and possibly some further content analysis, a compression strategy is developed (608). Here, compression refers to the intermediate compression applied to the media prior to transferring it to the server, where it will be decompressed (as necessary) prior to transcoding. The compression strategy may involve determining a target threshold, as described earlier in conjunction with equations. For example, if a compression of 10% or less is desired, then global lossless compression may be adequate. If slightly more compression is desired, say up to 20%, and if the client is able to parse the media, then segmented lossless compression may be applied. If more compression is required, then lossy compression techniques may be used, including either or both of lossy intelligent compression and lossy baseband compression. When the output pixel resolution is a fraction of the input pixel resolution, then substantial compression can be achieved by decimating the pixel data. When pixel resolution must be maintained, but the bit rate must be substantially reduced, then some amount of increased quantization may be applied. Alternatively or additionally, at the cost of increased computation time, spatial estimation of nearly duplicate blocks may be performed within frames. When the quality of the content is desired to be maintained and prioritized, then global and segmented lossless compression techniques will be applied. If further compression is desired, a very conservative lossy intelligent and baseband compression may be applied.

The compression strategy (608) may be algorithmically determined, or it may be determined using a lookup table that incorporates historical experience with varying data formats and the effectiveness of different compression techniques.

Next, a chunk of data is loaded (610). This may be an entire media file, or a portion of a media file. As required by the compression strategy, the chunk of data is parsed and decoded to baseband (612). Each of the determined compression techniques may then be applied, either individually or in combination, as determined by the compression strategy. If lossy intelligent compression is to be applied (614), then this is done (616). If lossy baseband compression is to be applied (618), then this is done (620). If segmented lossless compression is to be applied (622), then this is done (624). If global lossless compression is to be applied (626), then this is done (628). Other orderings may be used. Some portions of the media file may be compressed with one set of techniques, and other portions of the media file may be compressed with different techniques. Additional or fewer techniques may be used.

The compressed data along with the parameters required for decompression are transmitted to the server (630). If the decompression parameters have been previously transmitted and have not changed, then they are not necessarily transmitted again. Parameters, such as, for example, metadata, may be transmitted with or separate from image or other media data. If the end of the file has been reached (632), then the process ends, otherwise another chunk of data is loaded (610) and the process continues from that point. The end of the file may also be defined as the end of the desired portion of content to be delivered to the server. For example, a content with duration of 10 minutes, the client may desire to deliver the portion starting at the 5^{th} minute through the 8^{th} minute.

Alternate techniques may be used, and the processing steps may be performed in a different order. For example, if the compression techniques are yielding compression value that are significantly different than the target, then the compression strategy may be reassessed, and the types of compression or the compression parameters may be adjusted.

FIG. 6B is an example of a flowchart of the processing that may be performed on a server (640) in conjunction with the processing of the server as shown in FIG. 6A. The transcoding control parameters and the compression parameters are received (642) from the client. A chunk of compressed media data is then received (644), decompressed (646), and stored or concatenated (648) to any previous data. The data may be stored on a hard disk, or stored in random access memory (RAM). Other storage locations may be used, provided that the data will be retrievable, either directly or indirectly, by the transcoder. If the end of file has been reached (650) the process ends, otherwise the server waits and retrieves more data (644) and the process continues. The end of the file may also be defined as the end of the desired portion of content to be received by the server. The decompression process (646) may be skipped if the format has not been changed beyond what the transcoder can understand.

FIG. 6C is an example of a flowchart of the processing that may be applied in conjunction with the transcoding (660) on the server. The decompressed media data is accessed (662), and the transcoding parameters are loaded (664). The transcoding parameters may include the desired file structure, the pixel resolution, the frame rate, the bit rate and any metadata. The transcoding is then applied (666). The transcoding process may require that the entire file be loaded before processing can start, or it may operate serially, as blocks of data become available. Because transcoding can be a computationally intensive process, the processing may be distributed to multiple cores or processors, either within the server or local computer, or distributed to other processors on other computers or servers. When the data transfer rates are sufficiently high, this may still result in a substantial time savings. Multiple files may be generated by the transcoder with different parameters. The generated files may be stored locally or may be transferred back to the client.

In one embodiment of the system, the user utilizes a client application that resides in a web browser to upload the content for transcoding. Alternatively, a standalone application or a plugin in an existing application of the client can be utilized to do similar uploads. Such a service may include a web browser that receives the uploaded content from the client and then makes it accessible to the transcoding service for further processing. The transcoding system accesses the content and performs the transcoding based on the client's requested transcoding parameters. For example, if the parameters are based on a user-chosen profile such as “iPod” or “Flash (high resolution),” then the parameters may already be defined on the webserver or in the transcoding system. If the user is given additional choices to fine tune the transcoding, then the client may provide this information for the transcoder to use.

While the invention has been described above by reference to various embodiments, it will be understood that many changes and modifications can be made without departing from the scope of the invention. For example, decisions 614, 618, 622 and 626 may be performed an any order, and the compression processes 616, 620, 624 and 628 may not necessarily execute immediately after their respective decisions 614, 618, 622 and 626. Another example would be the merging of the Server (640) and the Transcoder (660) Processing where subsequent step to receiving the chunk of data (644), the transcoding (666) is applied and are executed in parallel to the receipt of the compression parameters (642) and loading of transcoding parameters (664). In an additional example, the responsibilities of the Client Processing (600) may be distributed among multiple computers such as a desktop and a server where the user on the desktop determines the transcoding parameters, and the server, which already has the original content, compresses and delivers to Server Processing (640) system. Multiple tiers of Client Processing (600), Server Processing (640), and Transcoder Processing (660) may be used for scalability and high availability.

It is therefore intended that the foregoing detailed description be understood as an illustration of the presently preferred embodiments of the invention, and not as a definition of the invention. It is only the following claims, including all equivalents that are intended to define the scope of the invention.

What is claimed is:

1. A method of transferring media content from a first computer system to a second computer system, comprising:
the first computer system determining a type of processing to be applied to the media content following transfer; and
prior to transferring the media content, the first computer system compressing the media content using a compression method chosen by the first computer system from a plurality of available compression methods, the compression method being chosen at least in part according to the type of processing to be applied to the media content following transfer;
wherein the type of processing to be applied to the media content following transfer comprises at least file compression.

2. The method of claim 1 wherein the type of processing to be applied to the media content following transfer comprises transcoding.

3. A method of claim 2 wherein the type of processing to be applied to the media content following transfer is determined at least in part by the first computer system.

4. The method of claim 2 wherein the type of processing to be applied to the media content following transfer is determined at least in part by the second computer system.

5. The method of claim 2, wherein the media content is a file containing, at least in part, one or more types of content from the set consisting of video data, audio data, and images.

6. The method of claim 2 wherein the media on the first computer system is of type MPEG-2, and wherein the processing to be applied to the media following transfer is to convert the data to a format selected from the set of MPEG-4 and H.264.

7. The method of claim 2 wherein the compressing uses knowledge of the structure of the media content.

8. The method of claim 2, further comprising:
transferring the compressed media to the second computer system, and
decompressing the compressed media on the second computer system.

9. The method of claim 8, wherein the compression is a lossless compression.

10. The method of claim 8, wherein the compression comprises at least in part lossy compression

11. A computer system for transferring media content to another computer system, comprising:
an interface for determining a type of processing to be applied to the media content following transfer; and
a processor for, prior to transferring the media content, compressing the media content using a compression method chosen from a plurality of available compression methods, the compression method being chosen at least in part according to the type of processing to be applied to the media content following transfer;
wherein the type of processing to be applied to the media content following transfer comprises at least file compression.

12. The apparatus of claim 11 wherein the type of processing to be applied to the media content following transfer comprises transcoding.

13. A computer-readable medium comprising instructions for transferring media content from a first computer system to a second computer system, comprising instructions for:
the first computer system determining a type of processing to be applied to the media content following transfer; and
prior to transferring the media content, the first computer system compressing the media content using a compression method chosen by the first computer system from a plurality of available compression methods, the compression method being chosen at least in part according to the type of processing to be applied to the media content following transfer;
wherein the type of processing to be applied to the media content following transfer comprises at least file compression.

14. The computer-readable medium of claim 13 wherein the type of processing to be applied to the media content following transfer comprises transcoding.

15. A method of transferring media content from a first computer system to a second computer system, comprising:
the second computer system communicating with the first computer system to determine a type of processing to be applied to the media content following transfer;
the second computer system receiving the media content from the first computer system, the media content having been compressed using a compression method chosen by the first computer system from a plurality of available compression methods, the compression method having been chosen at least in part according to the type of processing to be applied to the media content following transfer; and
the second computer system applying the type of processing to the media content, wherein the type of processing comprises at least file compression.

16. The method of claim 15 wherein the type of processing comprises transcoding.

17. A computer-readable medium for transferring media content from a first computer system to a second computer system, comprising instructions for:
the second computer system communicating with the first computer system to determine a type of processing to be applied to the media content following transfer;
the second computer system receiving the media content from the first computer system, the media content having been compressed using a compression method chosen by the first computer system from a plurality of available compression methods, the compression method having been chosen at least in part according to the type of processing to be applied to the media content following transfer; and
the second computer system applying the type of processing to the media content, wherein the type of processing comprises at least file compression.

18. The method of claim 17 wherein the type of processing comprises transcoding.

19. A computer system for receiving transfer of media content from a remote computer system, comprising:
an interface for communicating with the remote computer system to determine a type of processing to be applied to the media content following transfer;
an interface for receiving the media content, the media content having been compressed using a compression method chosen by the remote computer system from a plurality of available compression methods, the compression method having been chosen at least in part according to the type of processing to be applied to the media content following transfer; and
a processor for applying the type of processing to the media content, wherein the type of processing comprises at least file compression.

20. The apparatus of claim 19 wherein the type of processing comprises transcoding.
